(19) United States
(12) Patent Application Publication
(10) Pub. No.: US 2020/0341519 A1
(43) Pub. Date: Oct. 29, 2020

(54) SCREEN PROTECTOR AND ELECTRONIC DEVICE INCORPORATING THE SAME

(71) Applicant: Curio Holding Company, Philadelphia, PA (US)

(72) Inventor: Dennis O'Donnell, Philadelphia, PA (US)

(21) Appl. No.: 16/846,992

(22) Filed: Apr. 13, 2020

Related U.S. Application Data
(60) Provisional application No. 62/839,103, filed on Apr. 26, 2019.

(51) Int. Cl. G06F 1/16; G06F 21/32; G06K 9/00

(52) U.S. Cl. CPC G06F 1/1656; G06F 21/32; G06F 2200/1634; G06F 2200/1633; G06K 9/0002

(57) ABSTRACT

A protected electronic device assembly that includes an electronic device having a display screen and an ultrasonic fingerprint scanner and a multi-layer screen protector that overlies and protects the display screen without rendering the ultrasonic fingerprint scanner inoperable. A multi-layer screen protector that is capable of being utilized on portable electronic devices that utilize the aforementioned ultrasonic fingerprint scanner technology.

### CROSS-REFERENCE TO RELATED APPLICATIONS

The present application claims priority to U.S. Provisional Patent Application Ser. No. 62/839,103, filed Apr. 26, 2019, the entirety of which is incorporated herein by reference.

### BACKGROUND

There is an incredible amount of private and personal information stored inside of people's mobile phones. Therefore, people tend to lock their mobile phones when not in use. Currently, the systems and applications in place for a user to unlock their mobile phone include entering a passcode, using a fingerprint scanner, and using facial recognition software. With regard to fingerprint scanners, these typically take the form of capacitive sensors or optical fingerprint sensors. However, the latest fingerprint technology uses ultrasonic sensors for user identification for locking/unlocking of the phone. However, accessories that are currently on the market, when attached to the phone for various purposes including screen protection and the like, have a tendency to render the ultrasonic fingerprint sensors incapable of adequately performing their function. Thus, a need exists for a mobile phone or other electronic device that utilizes ultrasonic fingerprint sensor technology and includes a screen protector that is compatible therewith.

### BRIEF SUMMARY

The present invention is directed to a protected electronic device assembly that includes an electronic device having a display screen and an ultrasonic fingerprint scanner and a multi-layer screen protector that overlies and protects the display screen without rendering the ultrasonic fingerprint scanner inoperable. The present invention is also directed to a multi-layer screen protector that is capable of being utilized on portable electronic devices that utilize the aforementioned ultrasonic fingerprint scanner technology.

In one aspect, the invention may be a protected electronic device assembly comprising: an electronic device comprising: a display screen; and an in-display ultrasonic fingerprint scanner having a transmitter configured to generate ultrasonic energy having a frequency (f) and a receiver configured to receive reflected ultrasonic energy; and a multi-layer screen protector sheet coupled to and overlying the display screen, the multi-layer screen protector sheet comprising a plurality of layers, each of the layers having a thickness (t) and formed of a material having a speed of sound (v), wherein each of the layers is configured to satisfy equation:

$$t = 0.5 n \times \frac{v}{f}$$

wherein n is a whole integer greater than or equal to 1.

In another aspect, the invention may be a protected electronic device assembly comprising: an electronic device comprising: a display screen; and an in-display ultrasonic fingerprint scanner having a transmitter configured to generate ultrasonic energy and a receiver configured to receive reflected ultrasonic energy; and a multi-layer screen protector sheet coupled to and overlying the display screen, the multi-layer screen protector sheet comprising a substrate layer and an adhesive layer that adheres the multi-layer screen protector sheet to the display screen, the adhesive layer being an ultraviolet cured pressure sensitive adhesive.

In yet another aspect, the invention may be a protected electronic device assembly comprising: an electronic device comprising: a display screen; and an in-display ultrasonic fingerprint scanner having a transmitter configured to generate ultrasonic energy and a receiver configured to receive reflected ultrasonic energy; and a multi-layer screen protector sheet coupled to and overlying the display screen, the multi-layer screen protector sheet comprising a substrate layer and an adhesive layer that adheres the multi-layer screen protector sheet to the display screen, the substrate layer formed of a thermoplastic polyurethane.

In still another aspect, the invention may be a multi-layer screen protector sheet comprising: a substrate layer formed of a thermoplastic polyurethane; and an adhesive layer forming an exposed lower surface of the multi-layer screen protector sheet opposite an exposed uppermost surface of the multi-layer screen protector sheet, the adhesive layer being a curable pressure sensitive adhesive comprising a photo-initiator.

In a further aspect, the invention may be a method of protecting an electronic device comprising a display screen and in-display ultrasonic fingerprint scanner having a transmitter configured to generate ultrasonic energy and a receiver configured to receive reflected ultrasonic energy, the method comprising: a) providing a multi-layer screen protector sheet having an adhesive layer forming an exposed lower surface of the multi-layer screen protector sheet, the adhesive layer being a curable pressure sensitive adhesive comprising a photo-initiator; b) pressing the multi-layer screen protector sheet against the display screen so that the adhesive layer adheres the multi-layer screen protector sheet to the display screen; and c) applying light energy to the adhesive layer, thereby activating the photo-initiator and curing the pressure sensitive adhesive.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front perspective view of a protected electronic device assembly in accordance with an embodiment of the present invention;

FIG. 2 is an exploded perspective view of the protected electronic device assembly of FIG. 1 illustrating an electronic device and a multi-layer screen protector sheet;

FIG. 3 is an exploded side view of the protected electronic device assembly of FIG. 1 illustrating the electronic device and the multi-layer screen protector sheet;

FIG. 4 is a block diagram of the electronic device of the protected electronic device assembly of FIG. 1, schematically illustrating some, but not all, of its components;

FIG. 5 is a cross-sectional view taken through the multi-layer screen protector sheet along line V-V of FIG. 3; and

FIG. 6 is a cross-sectional view taken through the protected electronic device assembly along line VI-VI of FIG. 1.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features, the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” means less than about 0.1 wt. % based on the total of the referenced value.

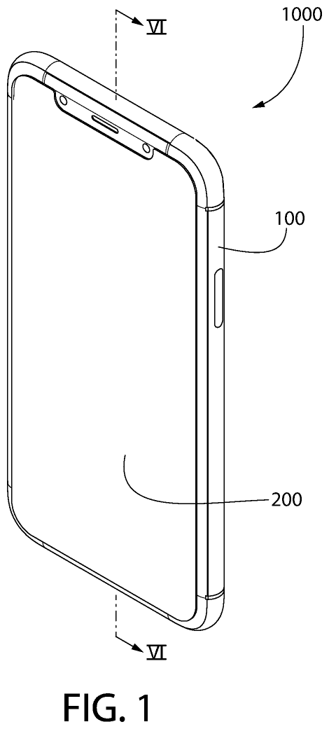

Referring to FIGS. 1-3, a protected electronic device assembly 1000 is illustrated in accordance with an embodiment of the present invention. The protected electronic device assembly 1000 comprises an electronic device 100 and a multi-layer screen protector sheet 200 that is configured to be coupled to the electronic device 100 to protect portions thereof as described herein below. In the exemplified embodiment, the electronic device 100 is a cellular phone or mobile phone. However, the invention is not to be so limited in all embodiments. Thus, in some alternative embodiments the electronic device 100 may be any electronic device having a display screen that is desired to be protected against breakage in the event that the electronic device is dropped or hit against a hard surface or structure. For example, the electronic device 100 may be a cellular/mobile phone, a tablet, a laptop, a smartphone, an e-reader, an MP3 player, an electronic toy, or the like. In some embodiments, the electronic device 100 may be any piece of lightweight, electrically-powered equipment, such as those typically used as consumer electronic devices capable of communications, data processing, and/or utility.

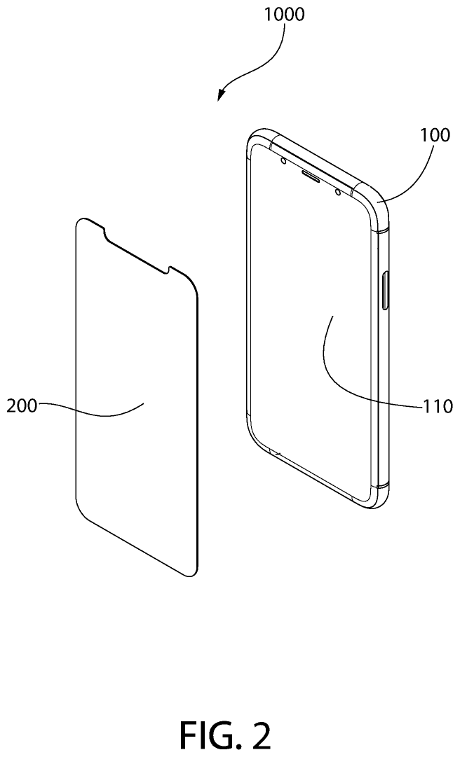

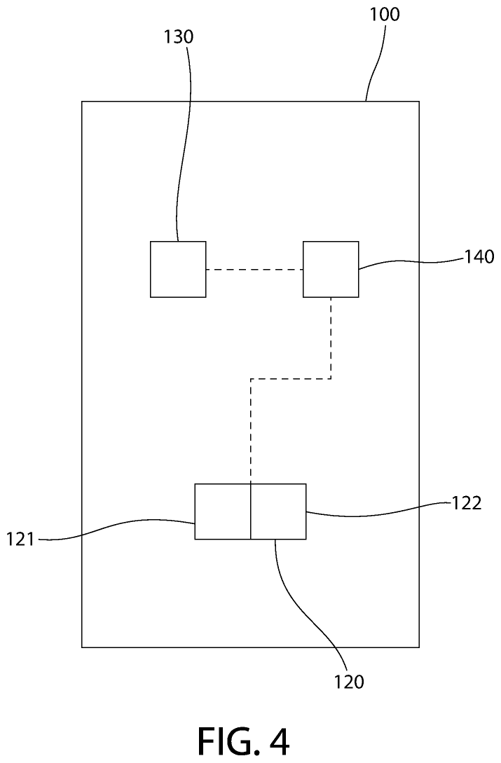

Referring to FIGS. 2 and 4, in the exemplified embodiment the electronic device 100 comprises a display screen 110, an ultrasonic fingerprint scanner 120, a power source 130, and a processor 140. The display screen 110 may include several layers, including an LCD display, a capacitive layer (necessary for some touch screens), and a glass cover, which may be made from hard glass such as aluminosilicate glass (aluminum, silicon, and oxygen), glass layers made from lab-made sapphire, or the like. The glass cover may be designed to resist shattering and scratching, even when dropped, although as is well known by electronic device users, these cover layers do still crack and shatter. Repair of a display screen can be expensive, and users therefore often cover the display screen (and specifically the glass cover thereof) with a protective screen cover so that the protective screen cover breaks, shatters, or cracks before the glass cover.

The ultrasonic fingerprint scanner 120 and the power source 130 are operably coupled to the processor 140. Thus, the power source 130 (which may be a battery or any other device capable of supplying power to other electronic components) powers the processor 140 and the fingerprint scanner 120. Furthermore, the processor 140 can receive information/data from the ultrasonic fingerprint scanner 120 and process that information/data to determine if a person attempting to gain entry into the electronic device 100 is an owner or other authorized user of the electronic device 100. Although the ultrasonic fingerprint scanner 120, the power source 130, and the processor 140 are the only electrical components illustrated in the block diagram of FIG. 4, it should be appreciated that the electronic device 100 will also include any other electrical components necessary to enable the electronic device 100 to function as intended. Thus, for example, the electronic device 100 may also comprise microphone(s), speaker(s), Bluetooth sensor(s), antenna(s), memory, keyboard(s), circuit boards, and the like. Depending on the particular use and type of device, the electronic device 100 may include additional components further to those described herein.

The processor 140 described herein may be any central processing unit (CPU), microprocessor, micro-controller, computational, or programmable device or circuit configured for executing computer program instructions (e.g. code). Various processors may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc. In the exemplified embodiment, the processor 140 is operably coupled to the power source 130 to power each of the other electrical components and the processor 140 is operably coupled to the ultrasonic fingerprint scanner 120 to determine whether a person attempting to gain access to the electronic device 100 is the owner (or an authorized user) of the electronic device 100.

In the exemplified embodiment, the ultrasonic fingerprint scanner 120 is located beneath the display screen 110 so it can detect a fingerprint when a user presses his/her finger onto the display screen 110. Thus, the ultrasonic fingerprint scanner 120 is described at some points in this disclosure as being an “in-display” ultrasonic fingerprint scanner 120, which means that it is located within or beneath the display screen 110 of the electronic device 100. The ultrasonic fingerprint scanner 120 may be capable of operating through glass (such as the display screen 110) and other materials (such as the multi-layer screen protector sheet 200) that are up to 800 microns thick combined. Of course, in other embodiments the ultrasonic fingerprint scanner 120 may be capable of operating through material that is even greater than 800 microns thick. The ultrasonic fingerprint scanner 120 makes use of very high-frequency ultrasonic sound to generate a 3D map of the fingerprint. The ultrasonic fingerprint scanner 120 then works in conjunction with the processor 140 to determine whether the finger being pressed against the screen has a fingerprint that matches a pre-stored fingerprint. The ultrasonic fingerprint scanner 120 comprises a transmitter 121 that is configured to generate ultrasonic energy having a frequency (f) and a receiver 122 that is configured to receive reflected ultrasonic energy. The frequency (f) of the ultrasonic energy generated by the transmitter 121 may be between 8 MHz and 15 MHz, more specifically between 10 MHz and 13 MHz, and still more specifically approximately 11.75 MHz

When a user places his/her finger against the display screen 110 and over the ultrasonic fingerprint scanner 120, an ultrasonic pulse is transmitted by the transmitter 121 of the ultrasonic fingerprint scanner 120 to the finger that is being pressed against the display screen 110. A first portion of the pulse is absorbed and a second portion of the pulse is bounced back to the receiver 122 of the ultrasonic fingerprint scanner 120. The exact portion of the pulse that bounces back is dependent upon the location, size, and other features of the ridges, pores, and other details that are unique to each fingerprint. The receiver 122 is configured to receive the second portion of the pulse that is bounced back to detect mechanical stress and calculate the intensity of the returning ultrasonic pulse at different points on the ultrasonic fingerprint scanner 120. The ultrasonic fingerprint scanner 120, perhaps in conjunction with the processor 140, can then utilize this information to determine whether the finger being pressed against the display screen has a fingerprint that matches a stored fingerprint. Such ultrasonic fingerprint scanners can make highly detailed 3D reproductions of the scanned fingerprint, making it much more difficult to forge the authorized user's fingerprint such that these systems are more secure than capacitive and optical sensors/scanners.

One drawback with electronic devices that include such ultrasonic fingerprint scanners is that they do not function properly when using certain off-the-shelf tempered glass screen protectors, which are used very commonly to protect the display screen. Essentially, it has been found that most currently available off-the-shelf screen protectors interfere with the ultrasonic pulse transmitted by the transmitter 121 of the ultrasonic fingerprint scanner 120 so that it is unable to work properly. One of the theories behind this problem is that the adhesive used to glue the screen protector onto the display screen of the device creates a thin air gap, which prevents the ultrasonic fingerprint scanner from working properly. One solution to this problem is to cut a hole in the screen protector at the location of the ultrasonic fingerprint scanner, which is not a good long-term solution to this issue because it will not prevent the underlying display screen from cracking particularly if it is dropped such that a hard item (i.e., a rock or the like) contacts the display screen through the hole in the screen protector. Furthermore, this solution can be considered unsightly and gives a roughened surface texture to a user when scrolling his/her finger across the screen. Thus, there is a great need to create a screen protector that adequately protects the display screen against damage and cracking in the event that the electronic device is dropped while also not interfering with the work of the ultrasonic fingerprint scanner.

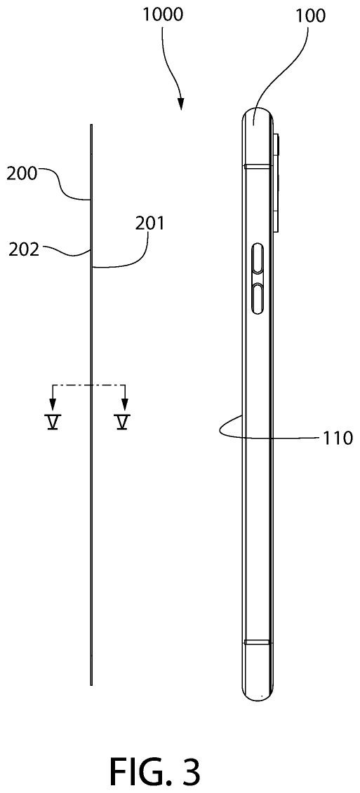

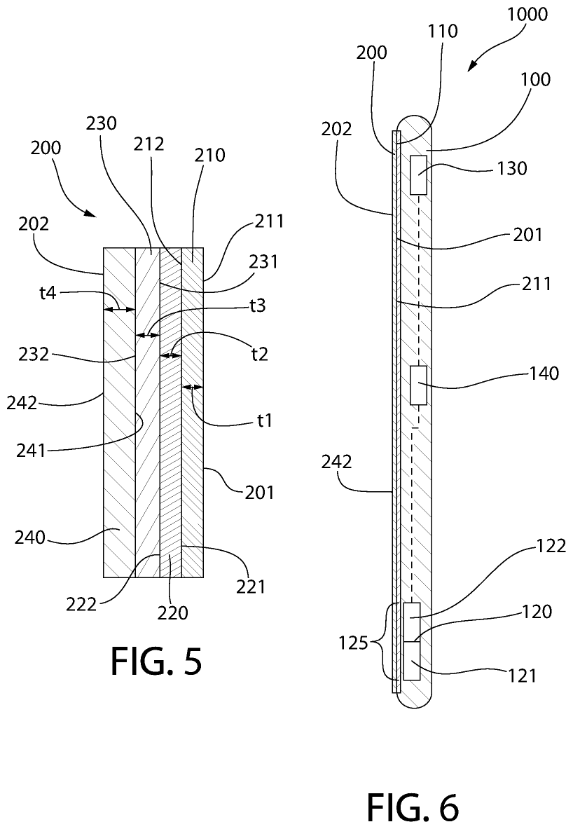

Referring to FIGS. 3 and 5, the multi-layer screen protector sheet 200 of the present invention will be described in detail. The multi-layer screen protector sheet 200 comprises a plurality of layers which includes a plurality of substrate layers and a plurality of adhesive layers. Specifically, the multi-layer screen protector sheet 200 comprises a first adhesive layer 210 having a first surface 211 and a second surface 212, a first substrate layer 220 having a first surface 221 and a second surface 222, a second adhesive layer 230 having a first surface 231 and a second surface 232, and a second substrate layer 240 having a first surface 241 and a second surface 242. Thus, in the exemplified embodiment the multi-layer screen protector sheet 200 comprises four layers, although more or less than four layers could be used in alternative embodiments. In the exemplified embodiment, each of the first and second surfaces 211, 212, 221, 222, 231, 232, 241, 242 of each of the first, second, third, and fourth layers 210, 220, 230, 240 is a major surface of that layer.

In the exemplified embodiment, the first adhesive layer 210 and the second adhesive layer 230 are adhesive layers and the first substrate layer 220 and the second substrate layer 240 are substrate layers. The multi-layer screen protector sheet 200 comprises an exposed lower surface 201 and an exposed upper surface 202. In the exemplified embodiment, the first surface 211 of the first adhesive layer 210 forms the exposed lower surface 201 of the multi-layer screen protector sheet 200 and the second surface 242 of the second substrate layer 240 forms the exposed upper surface 202 of the multi-layer screen protector sheet 200. The exposed lower surface 201 of the multi-layer screen protector sheet 200 is in contact with an outer surface of the display screen 110 of the electronic device 100 when the multi-layer screen protector sheet 200 is coupled to the display screen 110. Thus, the exposed upper surface 202 of the multi-layer screen protector sheet 200 is exposed and available for contact by a user when the multi-layer screen protector sheet 200 is coupled to the display screen 110 of the electronic device 100. The multi-layer screen protector sheet 200 preferably covers an entirety of the display screen 110. In some embodiments, the multi-layer screen protector sheet 200 is coupled to the display screen 110 so as to overlie the display screen 110. Furthermore, the multi-layer screen protector sheet 200 overlies an area of the display screen 110 that includes or is directly above the ultrasonic fingerprint scanner 120, as described further below with reference to FIG. 6.

In some exemplary embodiments, the first adhesive layer 210 is an ultraviolet cured pressure sensitive adhesive. Thus, the first adhesive layer 210 may be a hybrid of a traditional pressure-sensitive adhesive and a traditional ultraviolet cured adhesive. In some embodiments, the first adhesive layer 210 may be a curable pressure sensitive adhesive comprising a photo-initiator. Of course, the first adhesive layer 210 may be other types of adhesive in other embodiments so long as it does not interfere with the ultrasonic energy being generated by and received to the ultrasonic fingerprint scanner 120. The second adhesive layer 230 may be a pressure-sensitive adhesive, a UV cured adhesive, or a hybrid ultraviolet cured pressure sensitive adhesive similar to the first adhesive layer 21.

The first substrate layer 220 may be formed from polyethylene terephthalate (PET) (e.g., polyester) and/or poly(methyl methacrylate) (PMMA) (e.g., acrylic). The second substrate layer 240, which is the layer that forms the exposed upper surface 202 of the multi-layer screen protector sheet 200, may be formed from a thermoplastic polyurethane (TPU).

The first adhesive layer 210 forms the exposed lower surface 201 of the multi-layer screen protector sheet 200, which is the surface that is adhered or bonded to the display screen 110 of the electronic device 100. Thus, when the protected electronic device 1000 is assembled as shown, for example, in FIG. 6, the first adhesive layer 210 is located between and adheres the first surface 221 of the first substrate layer 220 of the multi-layer screen protector 200 to the display screen 110 of the electronic device 100. As noted above, in some embodiments the first adhesive layer 210 is an ultraviolet cured pressure sensitive adhesive that adheres the multi-layer screen protector sheet 200 to the display screen 110 of the electronic device 100. The second adhesive layer 230 is located between and adheres the second surface 222 of the first substrate layer 220 to the first surface 241 of the second substrate layer 240.

The first adhesive layer 210 has a first thickness t1 measured between the first and second surfaces 211, 212 thereof and the material of the first adhesive layer 210 has a speed of sound v1. The first substrate layer 220 has a second thickness t2 measured between the first and second surfaces 221, 222 thereof and the material of the first substrate layer 220 has a speed of sound v2. The second adhesive layer 230 has a third thickness t3 measured between the first and second surfaces 231, 232 thereof and the material of the second adhesive layer 230 has a speed of sound v3. The second substrate layer 240 has a fourth thickness t4 measured between the first and second surfaces 241, 242 thereof and the material of the second substrate layer 240 has a fourth speed of sound v4. Thus, v1, v2, v3, and v4 are the speed of sound through the various layers of the multi-layer screen protector sheet 200. Stated another way, the speed of sound through the first adhesive layer 210 is v1, the speed of sound through the first substrate layer 220 is v2, the speed of sound through the second adhesive layer 230 is v3, and the speed of sound through the second substrate layer 240 is v4.

Each of the layers is configured to satisfy the equation

$$t = 0.5 n \times \frac{v}{f} ,$$

wherein n is a whole integer greater than or equal to 1, v is the speed of sound through the relevant layer, f is the frequency of the ultrasonic energy generated by the transmitter 121 of the ultrasonic fingerprint scanner, and t is the thickness of the relevant layer. Thus, the first adhesive layer 210 is configured to satisfy the equation

$$t 1 = 0.5 n \times \frac{v 1}{f} ,$$

the first substrate layer 220 is configured to satisfy the equation

$$t 2 = 0.5 n \times \frac{v 2}{f} ,$$

the second adhesive layer 230 is configured to satisfy the equation

$$t 3 = 0.5 n \times \frac{v 3}{f} ,$$

and the second substrate layer 240 is configured to satisfy the equation

$$t 4 = 0.5 n \times \frac{v4}{f} .$$

In some embodiments, for each of the first and second substrate layers 220, 240, the speed of sound v2, v4 is greater than or equal to 1000 meters per second, more specifically greater than or equal to 1500 meters per second, still more specifically greater than or equal to 1800 meters per second, and still more specifically greater than or equal to 2000 meters per second.

As should be appreciated

$$\frac{v}{f}$$

is λ, which is wavelength (or the distance between the crests of a wave). Thus. the thickness of each layer can be modified within the confines of the equation set forth above so that the wavelength of the ultrasonic energy through each layer is either 0.5*λ or positive whole integer multiples thereof. This ensures that the layers of the multi-layer screen protector sheet 200 do not interfere with the ultrasonic energy generated by the ultrasonic fingerprint scanner 120. Thus, stated another way, the thickness of each layer of the multi-layer screen protector sheet 200 is tuned specifically to the speed of sound through the material of that layer so that the wavelength is 0.5*λ or positive whole integer multiples thereof. This enables the multi-layer screen protector sheet 200 to be created whereby sound waves (i.e., the ultrasonic energy generated by the transmitter 121 of the ultrasound fingerprint scanner 120) can pass through each layer at the exact point of 0.5*λ or positive integer multiples thereof to prevent distortion and noise.

The speed of sound through a particular material is determined by many factors, including hardness and density. Thus, differences in hardness and density for a particular layer of the multi-layer screen protector sheet 200 will result in differences in thickness for that particular layer to ensure that it satisfies the above-mentioned equation. For example, if you make a layer softer, this may decrease the speed of sound through that layer, which will then require that layer to be thicker. Alternatively, if the thickness being used is sub-optimal, one may harden the layer in question and then thin it out to ensure that it satisfies the above equation.

In some embodiments, each of the first and second substrate layers 220, 240 has an acoustical impedance that is equal to or less than 2.4 MRayls.

In some embodiments, the multi-layer screen protector sheet 200 has a total thickness that is between 6 mils and 20 mils. Furthermore, in some embodiments the multi-layer screen protector sheet 200 has a total thickness that is greater than 10 mils. In other embodiments, the multi-layer screen protector sheet 200 has a total thickness than is greater than 15 mils. The first and second adhesive layers 210, 230 may have the same thicknesses or different thicknesses. Similarly, the first and second substrate layers 220, 240 may have the same thicknesses or different thicknesses when compared to one another and when compared to the first and second adhesive layers 210, 230. As noted above, the thickness of each layer can be modified within the parameters of the equation set forth above to ensure that the material of the layers of the multi-layer screen protector sheet 200 does not interfere with the ultrasonic energy generated by the ultrasonic fingerprint scanner 120.

FIG. 6 illustrates the protected electronic device 1000 including the electronic device 100 and the multi-layer screen protector sheet 200 coupled thereto. As seen in FIG. 6, the ultrasonic fingerprint scanner 120 is located in a zone 125 of the display screen 110. Specifically, the portion of the display screen 110 that directly overlies and is aligned with the ultrasonic fingerprint scanner 120 forms the zone 125 of the display screen 110. In the exemplified embodiment, the multi-layer screen protector sheet 200 overlies and covers the zone 125 of the display screen 110. What this means is that there is no hole or opening in the multi-layer screen protector sheet 220 in alignment with the ultrasonic fingerprint scanner 120 as has been done with prior off-the-shelf screen protectors to deal with the issue of the screen protector causing the ultrasonic fingerprint scanner 120 to not work. Rather, in the invention described herein, the multi-layer screen protector sheet 200 is tuned and made specifically so that it can be placed over top of the portion of the display screen 110 that directly covers the ultrasonic fingerprint scanner 120 without affecting the function of the ultrasonic fingerprint scanner 120.

In some embodiments, the invention may be directed to a method of protecting the electronic device 100 comprising the display screen 110 and ultrasonic fingerprint scanner 120. Such a method may comprise providing the multi-layer screen protector sheet 200 having the first adhesive layer 210 that forms the exposed lower surface 201 of the multi-layer screen protector sheet 200. In some embodiments, the first adhesive layer 210 may be a curable pressure sensitive adhesive comprising a photo-initiator. Next, the multi-layer screen protector sheet 200 may be pressed against the display screen 110 so that the first adhesive layer 210 adheres the multi-layer screen protector sheet 200 to the display screen 110 of the electronic device 100. Finally, the method may include applying light energy to the first adhesive layer 210, thereby activating the photo-initiator and curing the pressure sensitive adhesive. The end result is that the multi-layer screen protector sheet 200 is coupled to the display screen 110 of the electronic device 100 as shown in FIG. 6.

While the invention has been described with respect to specific examples including presently preferred modes of carrying out the invention, those skilled in the art will appreciate that there are numerous variations and permutations of the above described systems and techniques. It is to be understood that other embodiments may be utilized, and structural and functional modifications may be made without departing from the scope of the present invention. Thus, the spirit and scope of the invention should be construed broadly as set forth in the appended claims.

What is claimed is:

1. A protected electronic device assembly comprising:
an electronic device comprising:
a display screen; and
an in-display ultrasonic fingerprint scanner having a transmitter configured to generate ultrasonic energy having a frequency (f) and a receiver configured to receive reflected ultrasonic energy; and
a multi-layer screen protector sheet coupled to and overlying the display screen, the multi-layer screen protector sheet comprising a plurality of layers, each of the layers having a thickness (t) and formed of a material having a speed of sound (v), wherein each of the layers is configured to satisfy equation:
$$t = 0.5 n \times \frac{v}{f}$$
wherein n is a whole integer greater than or equal to 1.

2. The protected electronic device assembly according to claim 1 further comprising:
the multi-layer screen protector sheet comprising a plurality of substrate layers and a plurality of adhesive layers; and
wherein, for each of the plurality of substrate layers, the v is greater than or equal to 2000 meters per second.

3. The protected electronic device assembly according to claim 2 wherein each of the plurality of substrate layers has an acoustical impedance that is equal to or less than 2.4 MRayls.

4. The protected electronic device assembly according to claim 2 wherein the plurality of substrate layers comprises: a first substrate layer formed of a poly(methyl methacrylate), a polyethylene terephthalate, or a polyethylene terephthalate polyester; and a second substrate layer formed of thermoplastic polyurethane.

5. The protected electronic device assembly according to claim 2 wherein at least one of the plurality of adhesive layers is an ultraviolet cured pressure sensitive adhesive.

6. The protected electronic device assembly according to claim 5 wherein the ultraviolet cured pressure sensitive adhesive adheres the multi-layer screen protector sheet to the display screen.

7. The protected electronic device assembly according to claim 1 wherein the multi-layer screen protector sheet comprises:
a first substrate layer having a first major surface and a second major surface;
a second substrate layer having a first major surface and a second major surface that forms an exposed outermost surface of the multi-layer screen protector sheet;
a first adhesive layer located between and adhering the first major surface of the first substrate layer to the display screen; and
a second adhesive layer located between and adhering the second major surface of the first substrate layer to the first major surface of the second substrate layer.

8. The protected electronic device assembly according to claim 7 wherein the first adhesive layer is formed of an ultraviolet cured pressure sensitive adhesive.

9. The protected electronic device assembly according to claim 7 wherein the first substrate layer is formed of a poly(methyl methacrylate), a polyethylene terephthalate, or a polyethylene terephthalate polyester.

10. The protected electronic device assembly according to claim 7 wherein the second substrate layer is formed of a thermoplastic polyurethane.

11. The protected electronic device assembly according to claim 1 wherein the multi-layer screen protector sheet has a total thickness between 6 mils to 20 mils.

12. The protected electronic device assembly according to claim 1 wherein the multi-layer screen protector sheet has a total thickness that is greater than 10 mils.

13. The protected electronic device assembly according to claim 1 wherein the in-display ultrasonic fingerprint scanner is located in a zone of the display screen, the multi-layer screen protector sheet overlying and covering the zone.

14. A protected electronic device assembly comprising:
an electronic device comprising:
a display screen; and
an in-display ultrasonic fingerprint scanner having a transmitter configured to generate ultrasonic energy and a receiver configured to receive reflected ultrasonic energy; and
a multi-layer screen protector sheet coupled to and overlying the display screen, the multi-layer screen protector sheet comprising a substrate layer and an adhesive layer that adheres the multi-layer screen protector sheet to the display screen, the adhesive layer being an ultraviolet cured pressure sensitive adhesive.

15. A protected electronic device assembly comprising:
an electronic device comprising:
a display screen; and
an in-display ultrasonic fingerprint scanner having a transmitter configured to generate ultrasonic energy and a receiver configured to receive reflected ultrasonic energy; and
a multi-layer screen protector sheet coupled to and overlying the display screen, the multi-layer screen protector sheet comprising a substrate layer and an adhesive layer that adheres the multi-layer screen protector sheet to the display screen, the substrate layer formed of a thermoplastic polyurethane.
